(19) United States
(12) Patent Application Publication
(10) Pub. No.: US 2023/0138061 A1
(43) Pub. Date: May 4, 2023

(54) AUXILIARY BATTERY SYSTEM OF VEHICLE AND METHOD FOR CONTROLLING THE AUXILIARY BATTERY SYSTEM

(71) Applicants: Hyundai Motor Company, Seoul (KR); Kia Corporation, Seoul (KR); SL Corporation, Daegu (KR)

(72) Inventors: Kyung Hyun Lim, Hwaseong (KR); Jun Su Shin, Gyeongsan (KR); Ji Woong Kang, Daegu (KR); Se Bong Jung, Daegu (KR)

(21) Appl. No.: 17/972,404

(22) Filed: Oct. 24, 2022

(30) Foreign Application Priority Data
Oct. 29, 2021 (KR) 10-2021-0146836

(51) Int. Cl. B60R 16/033; B60W 10/26; H02J 7/00

(52) U.S. Cl. CPC B60R 16/033; B60W 10/26; H02J 7/0063; H02J 7/0014; H02J 7/007182; H02J 7/0048

(57) ABSTRACT

Provided is an auxiliary battery system of a vehicle, the auxiliary battery system comprising an auxiliary battery of the vehicle, which comprises a plurality of cells, and a battery controller configured to perform balancing between voltages between the plurality of cells of the auxiliary battery, the battery controller comprising a cell balancing control unit configured to perform balancing based on voltages of the plurality of cells when ignition of the vehicle is ON, and perform balancing based on a voltage deviation between the plurality of cells when the ignition of the vehicle is OFF.

### CROSS REFERENCE TO RELATED APPLICATION

This application claims, under 35 U.S.C. § 119(a), the benefit of Korean Patent Application No. 10-2021-0146836, filed Oct. 29, 2021, the disclosure of which is incorporated herein by reference in its entirety.

### FIELD

Embodiments of the present disclosure relate to an auxiliary battery system of a vehicle and a method for controlling the auxiliary battery system, and more particularly, to an auxiliary battery system of a vehicle, which is capable of performing cell balancing on an auxiliary battery including a plurality of cells, and a method for controlling the auxiliary battery system.

### BACKGROUND

Cells included in a battery have different internal resistances, such that a deviation inevitably occurs in a state of charge of a cell as the use becomes longer.

That is, due to a speed difference between the fastest charging cell and the slowest charging cell, upon completion of charging of the slowest charging cell, the fastest charging cell may be in an over-voltage state. This cell may be rapidly discharged, and thus enter an over-discharged state. When over-charging or over-discharging progresses, the lifespan of the battery may rapidly decrease, and battery explosion may occur due to sharp voltage rise, thus causing fire.

That is, for safety reasons as well as for efficient management of the battery, battery cell balancing is very important.

Meanwhile, a lithium-ion phosphate battery is an auxiliary battery used in initial ignition of a vehicle. However, in the lithium-ion phosphate battery, for charging with a state of charge of 80% to 90% or higher, sharp voltage rise occurs due to decomposition of lithium, resulting in fire due to short-circuit caused by a cell deviation, and due to a capacity deviation between cells in charging, a fully charged cell causes voltage rise, such that a vehicle control unit may cut off power and stall may occur.

Moreover, when balancing is performed in a situation where a deviation between cells occurs during stop, the battery may be discharged, making ignition and driving of the vehicle impossible.

The matters described as the background art are merely for improving the understanding of the background of the present disclosure, and should not be accepted as acknowledging that they correspond to the existing technologies known to those of ordinary skill in the art.

### SUMMARY

The present disclosure is proposed to solve at least the aforementioned problems and aims to provide an auxiliary battery system of a vehicle, the auxiliary battery system comprising an auxiliary battery of the vehicle, which comprises a plurality of cells, and a battery controller configured to perform balancing between voltages of the plurality of cells, the battery controller comprising a cell balancing control unit configured to perform balancing based on the voltages of the plurality of cells when ignition of the vehicle is ON, and perform balancing based on a voltage deviation between the plurality of cells when the ignition of the vehicle is OFF.

An auxiliary battery system of a vehicle according to the present disclosure configured to achieve the foregoing objects may comprise an auxiliary battery of the vehicle, which comprises a plurality of cells, and a battery controller comprising a cell balancing control unit configured to perform balancing between voltages of the plurality of cells of the auxiliary battery, perform balancing based on the voltages of the plurality of cells when ignition of the vehicle is ON, and perform balancing based on a voltage deviation between the plurality of cells when the ignition of the vehicle is OFF.

When the ignition of the vehicle is ON, the cell balancing control unit may be further configured to perform balancing between the voltages of the plurality of cells when a voltage of any one of the plurality of cells is maintained greater than or equal to a first voltage, and terminate balancing between the voltages of the plurality of cells when the voltage of any one of the plurality of cells is lowered to a second voltage or less after performing balancing between the voltages of the cells.

The first voltage may be greater than the second voltage.

The cell balancing control unit may be further configured to terminate balancing between the voltages of the plurality of cells when a first limit time has elapsed, even though the voltage is not lowered to the second voltage or less, after performing balancing between the voltages of the plurality of cells.

When the ignition of the vehicle is OFF, the cell balancing control unit may be further configured to perform balancing between the voltages of the plurality of cells when a voltage deviation between a cell having the lowest voltage among the plurality of cells and the other cells is maintained greater than or equal to a first voltage deviation, and terminate balancing between the voltages of the plurality of cells when the voltage deviation is lowered to a second voltage deviation or less.

The first voltage deviation may be greater than the second voltage deviation.

The cell balancing control unit may be further configured to terminate balancing between the voltages of the plurality of cells when a second limit time has elapsed, even though the voltage deviation is not lowered to the second voltage or less, after performing balancing between the voltages of the plurality of cells.

When the ignition of the vehicle is OFF, the cell balancing control unit may be further configured to perform balancing between the voltages of the plurality of cells when a state of charge (SOC) of the auxiliary battery exceeds a first threshold value.

The auxiliary battery system of the vehicle may further comprise a power generation control unit configured to receive a state of the auxiliary battery from the battery controller, and, based on the state of the auxiliary battery, limit a power-generating voltage of the auxiliary battery, turn OFF a main relay of the auxiliary battery, or limit driving of an engine driving unit.

The battery controller may be further configured to determine the state of the auxiliary battery as any one of a normal state, an over-voltage state, and an over-temperature state and transmit the state to the power generation control unit, and the power generation control unit may be further configured to, based on the state of the auxiliary battery, limit the power-generating voltage, turn OFF the main relay of the auxiliary battery, or limit driving of the engine driving unit.

When the auxiliary battery is determined as being in the over-voltage state, the power generation control unit may be further configured to limit the power-generating voltage to prevent the power-generating voltage from exceeding a third voltage and to limit driving of the engine driving unit.

When the ignition of the vehicle is ON and the auxiliary battery is determined as being in the over-temperature state, the power generation control unit may be further configured to turn OFF the main relay of the auxiliary battery to block electrical connection of the auxiliary battery and maintain a voltage of a current supplied to the engine driving unit above a fourth voltage to prevent stall.

The fourth voltage may be greater than the third voltage.

When the ignition of the vehicle is OFF and the auxiliary battery is determined as being in the over-temperature state, the power generation control unit may be further configured to turn OFF the main relay of the auxiliary battery, turn OFF a main relay of a main battery having a higher supply voltage than the auxiliary battery, and transmit information about the over-temperature state of the auxiliary battery to a previously registered external terminal.

A method for controlling the auxiliary battery system of the vehicle may comprise determining ON or OFF of ignition of the vehicle, performing balancing based on voltages of cells of a battery when the ignition of the vehicle is ON, and performing balancing based on a voltage deviation between the cells when the ignition of the vehicle is OFF.

The method may further comprise receiving, by a power generation control unit configured to control power generation of the auxiliary battery, a state of the auxiliary battery from the battery controller, and limiting, by the power generation control unit, a power-generating voltage of the auxiliary battery, turning OFF a main relay of the auxiliary battery, or limiting driving of an engine driving unit, based on the state of the auxiliary battery.

According to the auxiliary battery system of the vehicle, cell balancing of the auxiliary battery may be performed according to the ON or OFF state of the ignition, such that the expected lifespan of the battery cell may be lengthened, and moreover, when occurrence of abnormality (over-voltage, over-temperature, etc.) in the auxiliary battery is detected through communication between the battery controller for performing cell balancing of the auxiliary battery and the power generation control unit for controlling power generation of the vehicle, an upper limit of a power-generating voltage for charging the auxiliary battery may be limited or the engine driving unit may be controlled to limit the vehicular speed or RPM of the vehicle, according to a type of abnormality, thereby suppressing a safety problem such as explosion, etc., caused by abnormality of the battery.

In a further aspect, vehicles are provided which comprise an auxiliary battery system as disclosed herein.

Other aspects are disclosed infra.

### BRIEF DESCRIPTION OF THE DRAWINGS

FIG. 1 is a schematic diagram of an auxiliary battery system of a vehicle, according to an exemplary embodiment of the present disclosure.

FIG. 2 is a flowchart of a method for controlling an auxiliary battery system of a vehicle, according to an exemplary embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Hereinafter, specific details for solving the above-mentioned objects and problems will be described in detail with reference to the accompanying drawings. In the drawings, the same reference numerals will be used throughout to designate the same or equivalent elements. In addition, a detailed description of well-known features or functions will be ruled out in order not to unnecessarily obscure the gist of the present disclosure. Meanwhile, when the detailed description of the known technology in the same field is not helpful in understanding the core matters of the present disclosure in understanding the present disclosure, the description will be omitted, and the technical spirit of the present disclosure is not limited thereto and may be variously implemented by those of ordinary skill in the art.

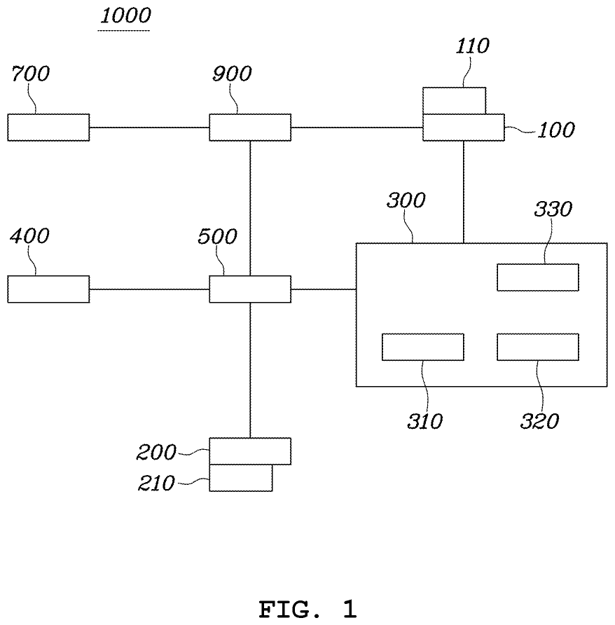

FIG. 1 is a schematic diagram of an auxiliary battery system of a vehicle, according to an exemplary embodiment of the present disclosure.

According to an exemplary embodiment, the present disclosure is intended to minimize a voltage difference between battery cells connected in series.

An auxiliary battery system 1000 of a vehicle according to an exemplary embodiment of the present disclosure may comprise an auxiliary battery 100 of the vehicle, which comprises a plurality of cells, and a battery controller 300 comprising a cell balancing control unit 310 configured to perform balancing between voltages of the plurality of cells of the auxiliary battery, perform balancing based on voltages of the plurality of cells when ignition (IG) of the vehicle is ON, and perform balancing based on a voltage deviation between the plurality of cells when the ignition of the vehicle is OFF.

The auxiliary battery 100 may be a lithium-ion phosphate battery used in hybrid vehicles. The auxiliary battery 100 may comprise four or more cells, and have a voltage of about 12V. The battery controller 300 may comprise therein a cell balancing control unit 310 for performing cell balancing of the auxiliary battery 100. The battery controller 300 may comprise therein a state machine 330 that determines a cell state (a cell voltage, a state of charge (SOC), a temperature, etc.) of the auxiliary battery 100 and determines whether the vehicle starts.

To each of the plurality of cells, a resistor for consuming power applied to the cell may be connected in parallel. Thus, when cell balancing is performed, current may be consumed through the resistor connected in parallel and thus charging may not progress.

Meanwhile, cell balancing of the auxiliary battery 100 may be performed through the following process.

In the case of ignition of the vehicle being ON, the cell balancing control unit 310 may be configured to perform balancing between the voltages of the plurality of cells when a voltage of any one of the plurality of cells is maintained greater than or equal to a first voltage, and terminate balancing between the voltages of the plurality of cells when the voltage of any one of the plurality of cells is lowered to a second voltage or less, after balancing between the voltages.

Herein, when the ignition of the vehicle is ON, i.e., the vehicle is being driven, the first voltage and the second voltage may be criteria for determining a need to perform cell balancing. At this time, the need for cell balancing may be determined based on a time for which the first voltage or the second voltage is maintained. For example, it may be determined that cell balancing is needed or terminated when the first voltage is maintained for 5 seconds or longer or the second voltage is maintained for 5 seconds or longer, and it may be determined that cell balancing is not needed and thus cell balancing may not be performed when the first voltage is maintained for less than 5 seconds.

When a voltage of a cell among the plurality of cells measured by the state machine 330 is greater than or equal to the first voltage, cell balancing may be performed for that cell. The first voltage may be greater than the second voltage.

However, the cell balancing control unit 310 may be configured to terminate balancing between the voltages of the plurality of cells when a first limit time has elapsed even though the voltage of the cell of the auxiliary battery 100 is not lowered to the second voltage or less, after performing balancing between the voltages of the plurality of cells.

For example, the first limit time may be 1 minute, and the cell balancing control unit 310 may be configured to automatically terminate cell balancing after the elapse of the first limit time, after which when a cell voltage measured by the state machine 330 is greater than or equal to the first voltage, the cell balancing control unit 310 may be configured to perform cell balancing again and may be configured to perform cell balancing for the first limit time. When the cell voltage is lowered to the second voltage or less by performing cell balancing for the first limit time, then cell balancing may not be performed thereafter.

In the case of the ignition of the vehicle being OFF, the cell balancing control unit 310 may be configured to perform balancing between the voltages of the plurality of cells when a voltage deviation between a cell having the lowest voltage among the plurality of cells and the other cells is maintained greater than or equal to a first voltage deviation, and terminate balancing between the voltages of the plurality of cells when the voltage deviation is lowered to a second voltage deviation or less after balancing between the voltages.

Herein, when the ignition of the vehicle is OFF, i.e., the vehicle is stopped, the first voltage deviation and the second voltage deviation may be criteria for determining a need to perform cell balancing. After the vehicle is stopped, cell charging is not performed, such that cell balancing may be determined by measuring a deviation, i.e., a difference, between the voltages of the cells, rather than measuring the voltages of the cells.

When a voltage difference between a cell having the lowest voltage among cell voltages measured by the state machine 330 and any one of the other cells is greater than or equal to a first voltage deviation, balancing may be performed for that cell, and when the voltage difference is less than or equal to the second voltage deviation, balancing may not be performed for that cell. The first voltage deviation may be greater than the second voltage deviation.

However, the cell balancing control unit 310 may be configured to terminate balancing between the voltages of the plurality of cells when a second limit time has elapsed even though the voltage deviation of the cell of the auxiliary battery 100 is not lowered to the second voltage deviation or less, after performing balancing between the voltages of the plurality of cells.

For example, the second limit time may be 1 minute, and the cell balancing control unit 310 may be configured to automatically terminate cell balancing after the elapse of the second limit time, after which when the voltage deviation is greater than or equal to the first voltage deviation, the cell balancing control unit 310 may be configured to perform cell balancing again and may be configured to perform cell balancing for the second limit time. When the cell voltage is lowered to the second voltage deviation or less by performing cell balancing for the second limit time, then cell balancing may not be performed thereafter.

On the other hand, the cell balancing control unit 310 may be configured to perform balancing between the voltages of the cells when an SOC of the auxiliary battery 100 exceeds a first threshold value, in the case of the ignition of the vehicle being OFF.

That is, cell balancing may be performed when the SOC of the auxiliary battery 100 measured by the state machine 330 exceeds the first threshold value, e.g., 50%. When the SOC measured by the state machine 330 is less than 50% after cell balancing is performed, cell balancing may not be performed any longer. In this way, even after the ignition is OFF, cell balancing may be prevented from being performed when the voltage deviation between the cells is greater than or equal to the first voltage deviation due to natural discharging, thereby preventing the auxiliary battery 100 from being fully discharged.

Meanwhile, referring to FIG. 1, the auxiliary battery system 1000 of the vehicle may further comprise a power generation control unit 500 that receives the state of the auxiliary battery 100 from the battery controller 300, and limits a power-generating voltage, turns OFF a main relay 110 of the auxiliary battery 100, or limits driving of an engine driving unit 700, based on the state of the auxiliary battery 100.

The battery controller 300 and the power generation control unit 500 each may comprise a communication unit (not shown), and the power generation control unit 500 may be configured to receive the state of the auxiliary battery 100 from the battery controller 300. In this case, the state of the auxiliary battery 100 may be classified into any one of a normal state, an over-voltage state, and an over-temperature state, which may be determined by a fault determining unit 320 included in the battery controller 300.

The power generation control unit 500 may be configured to limit a power-generating voltage, turn OFF the main relay 110 of the auxiliary battery 100, or limit driving of the engine driving unit 700, based on the determined state of the auxiliary battery 100.

When the auxiliary battery 100 is determined as being in the over-voltage state by the fault determining unit 320, the power generation control unit 500 may be configured to limit the power-generating voltage such that the power-generating voltage does not exceed a third voltage, and may be configured to limit driving of the engine driving unit 700 (herein, the third voltage may mean an upper limit of a voltage controlled by the power generation control unit 500 when the over-voltage state is determined).

The power generation control unit 500 may be electrically connected to a low direct current (DC)-DC converter (LDC) 900 electrically connected to the auxiliary battery 100 and the engine driving unit 700, and may be configured to control a voltage of electricity flowing from the LDC 900 to the auxiliary battery 100 or the engine driving unit 700 by controlling the LDC 900. Thus, when the auxiliary battery 100 is determined as being in the over-voltage state, the power generation control unit 500 may be configured to control the LDC 900 to prevent a voltage applied to the auxiliary battery 100 from exceeding the third voltage. For example, the LDC 900 may be controlled not to apply a voltage exceeding 13.5V such that an auxiliary battery of 12V is not maintained in the over-voltage state.

Moreover, by limiting a voltage or a current of electricity applied to the engine driving unit 700, RPM of an engine of the vehicle and a vehicular speed of the vehicle may be limited.

In this case, the engine driving unit 700 may refer to an engine, an oil pump, a cooling water pump, an alternator, etc., built in the vehicle, and the over-voltage state may be determined when a voltage of an individual cell, measured by the state machine 330, exceeds a specific voltage.

On the other hand, when the ignition of the vehicle is ON and the auxiliary battery 100 is determined as being in the over-temperature state, the power generation control unit 500 may be configured to turn OFF the main relay 110 of the auxiliary battery 100 to block electrical connection of the auxiliary battery 100 and maintain a voltage of a current supplied to the engine driving unit 700 as a fourth voltage or more to prevent stall (herein, the fourth voltage may mean a lower limit of the current supplied from the power generation control unit 500 to the engine driving unit 700 when the over-temperature state is determined).

More specifically, the auxiliary battery 100 may be determined as being in the over-temperature state when the temperature of the auxiliary battery 100, measured by the state machine 330, exceeds a particular temperature, e.g., 70° C.

In this case, when the voltage applied to the auxiliary battery 100 is continuously maintained, explosion may occur due to thermal runaway of the auxiliary battery 100, such that the power generation control unit 500 may be configured to turn OFF the main relay 110 of the auxiliary battery 100 to block electricity flowing to the auxiliary battery. However, to prevent stall during driving of the vehicle, a voltage greater than or equal to the fourth voltage, e.g., a voltage greater than or equal to 14V, may be applied to the alternator, to allow the vehicle to be continuously driven.

In this case, the fourth voltage applied to the engine driving unit 700 may be preferably greater than the third voltage applied to the auxiliary battery 100. This is because the fourth voltage is a voltage required for driving the engine driving unit 700 in the case of emergency, and is directly applied to the engine driving unit 700 to drive the vehicle, such that a voltage higher than a voltage for charging the auxiliary battery 100 may be required.

Meanwhile, when the ignition of the vehicle is OFF and the auxiliary battery 100 is determined as being in the over-temperature state by the fault determining unit 320, the power generation control unit 500 may be configured to turn OFF the main relay 110 of the auxiliary battery 100, turn OFF a main relay 210 of the main battery 200 having a higher supply voltage than that of the auxiliary battery 100, and transmit information about the over-temperature state of the auxiliary battery 100 to a previously registered external terminal 400.

That is, when the temperature of the auxiliary battery 100, measured by the state machine 330, exceeds, for example, 70° C. during OFF of the ignition of the vehicle, the main relays 110 and 210 of the auxiliary battery 100 and the main battery 200 may be turned OFF to block electrical connection therebetween. When the electrical connection between the auxiliary battery 100 and the main battery 200 is not blocked, the over-temperature state of the auxiliary battery 100 may affect the main battery 200, such that the electrical connection between the auxiliary battery 100 and the main battery 200 needs to be completely blocked.

The main battery 200 has a higher supply voltage than the auxiliary battery 100, and for example, the supply voltage of the main battery 200 may be 48V.

When the auxiliary battery 100 is determined as being in the over-temperature state in the OFF state of the ignition of the vehicle, information about the over-temperature state may be transmitted to the external terminal 400 (e.g., a smartphone of a driver) previously registered in the vehicle to allow the driver to quickly deal with the over-temperature state of the auxiliary battery 100 based on the information.

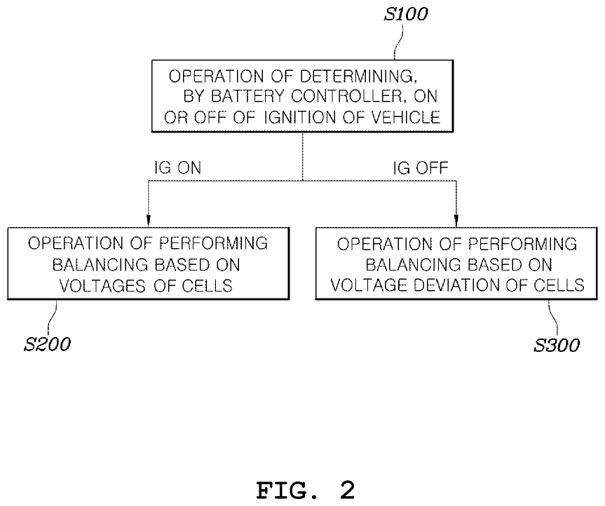

Meanwhile, referring to FIG. 2, a method for controlling the auxiliary battery system of the vehicle may comprise operation S100 of determining ON or OFF of the ignition of the vehicle, operation S200 of performing balancing based on a voltage of a battery cell when the ignition of the vehicle is ON, and operation S300 of performing balancing based on a voltage deviation of the battery cell when the ignition of the vehicle is OFF.

While the present disclosure has been shown and described in relation to specific embodiments thereof, it would be obvious to those of ordinary skill in the art that the present disclosure can be variously improved and changed without departing from the spirit of the present disclosure provided by the following claims.

What is claimed is:

1. An auxiliary battery system of a vehicle, comprising:
an auxiliary battery of a vehicle, the auxiliary battery comprising a plurality of cells; and
a battery controller configured to perform balancing between voltages of the plurality of cells of the auxiliary battery,
wherein the battery controller comprises a cell balancing control unit configured to:
perform balancing based on voltages of the plurality of cells when ignition of the vehicle is ON; and
perform balancing based on a voltage deviation between the plurality of cells when the ignition of the vehicle is OFF.

2. The auxiliary battery system of claim 1, wherein, when the ignition of the vehicle is ON, the cell balancing control unit is further configured to:
perform balancing between the voltages of the plurality of cells when a voltage of any one of the plurality of cells is maintained greater than or equal to a first voltage; and
terminate balancing between the voltages of the plurality of cells when the voltage of any one of the plurality of cells is lowered to a second voltage or less.

3. The auxiliary battery system of claim 2, wherein the first voltage is greater than the second voltage.

4. The auxiliary battery system of claim 2, wherein the cell balancing control unit is further configured to terminate balancing between the voltages of the plurality of cells when a first limit time has elapsed, even though the voltage is not lowered to the second voltage or less, after performing balancing between the voltages of the plurality of cells.

5. The auxiliary battery system of claim 1, wherein, when the ignition of the vehicle is OFF, the cell balancing control unit is further configured to:
perform balancing between the voltages of the plurality of cells when a voltage deviation between a cell having a lowest voltage among the plurality of cells and other cells is maintained greater than or equal to a first voltage deviation; and
terminate balancing between the voltages of the plurality of cells when the voltage deviation is lowered to a second voltage deviation or less.

6. The auxiliary battery system of claim 5, wherein the first voltage deviation is greater than the second voltage deviation.

7. The auxiliary battery system of claim 5, wherein the cell balancing control unit is further configured to terminate balancing between the voltages of the plurality of cells when a second limit time has elapsed, even though the voltage deviation is not lowered to the second voltage deviation or less, after performing balancing between the voltages of the plurality of cells.

8. The auxiliary battery system of claim 5, wherein, when the ignition of the vehicle is OFF, the cell balancing control unit is further configured to perform balancing between the voltages of the plurality of cells when a state of charge (SOC) of the auxiliary battery exceeds a first threshold value.

9. The auxiliary battery system of claim 1, further comprising a power generation control unit configured to:
receive a state of the auxiliary battery from the battery controller; and
based on the state of the auxiliary battery:
limit a power-generating voltage of the auxiliary battery;
turn OFF a main relay of the auxiliary battery; or
limit driving of an engine driving unit.

10. The auxiliary battery system of claim 9, wherein:
the battery controller is further configured to:
determine the state of the auxiliary battery as any one of:
a normal state;
an over-voltage state; and
an over-temperature state; and
transmit the determined state to the power generation control unit, and
the power generation control unit is further configured to, based on the state of the auxiliary battery:
limit the power-generating voltage;
turn OFF the main relay of the auxiliary battery; or
limit driving of the engine driving unit.

11. The auxiliary battery system of claim 10, wherein, when the auxiliary battery is determined as being in the over-voltage state, the power generation control unit is further configured to limit the power-generating voltage to prevent the power-generating voltage from exceeding a third voltage and to limit driving of the engine driving unit.

12. The auxiliary battery system of claim 10, wherein, when the ignition of the vehicle is ON and the auxiliary battery is determined as being in the over-temperature state, the power generation control unit is further configured to:
turn OFF the main relay of the auxiliary battery to block electrical connection of the auxiliary battery; and
maintain a voltage of a current supplied to the engine driving unit above a fourth voltage to prevent stall.

13. The auxiliary battery system of claim 12, wherein the fourth voltage is greater than a third voltage.

14. The auxiliary battery system of claim 10, wherein, when the ignition of the vehicle is OFF and the auxiliary battery is determined as being in the over-temperature state, the power generation control unit is further configured to:
turn OFF the main relay of the auxiliary battery;
turn OFF a main relay of a main battery having a higher supply voltage than the auxiliary battery; and
transmit information about the over-temperature state of the auxiliary battery to a previously registered external terminal.

15. A vehicle comprising an auxiliary battery system of claim 1.
